(19) United States
(12) Patent Application Publication
(10) Pub. No.: US 2002/0080407 A1
(43) Pub. Date: Jun. 27, 2002

(54) Print control unit

(75) Inventors: Fumihiro Hatayama, Kyoto (JP); Yasuhito Shiraishi, Kyoto (JP)

Correspondence Address: MCDERMOTT, WILL & EMERY, 600 13th Street, N.W., WASHINGTON, DC, 20005-3096, US

(73) Assignee: Dainippon Screen Mfg. Co., Ltd.

(21) Appl. No.: 10/025,672

(22) Filed: Dec. 26, 2001

(30) Foreign Application Priority Data
Dec. 26, 2000 (JP) 2000-394578

(51) Int. Cl. G06K 15/00; G06F 15/00

(52) U.S. Cl. 358/3.06; 358/1.15

(57) ABSTRACT

A controller (print control unit) comprises an image analyzing part automatically analyzing an image for printed matter and an inference part adjusting the value of a control parameter related to a printing Machine with fuzzy inference. The inference part acquires the feature of the image such as “solid”, “halftone” or “light” with the result of analysis by the image analyzing part, and decides each control parameter in response to the feature of the image. The printing machine makes printing output with the adjusted control parameter transmitted from the controller. The feature of the image may alternatively be supplied as an instruction from an operator through a feature specifying part. Thus, a print control unit capable of excellently and simply adjusting the control parameter for the printing machine in response to the feature of the printed image is provided.

### BACKGROUND OF THE INVENTION

1. Field of the Invention

The present invention relates to a print control unit supplying a print control instruction to a printing machine, and more particularly, it relates to a print control unit capable of properly adjusting each control parameter related to the printing machine.

2. Description of the Background Art

A printing machine may require fine adjustment responsive to the type of an image. More concretely, there are images such as an image referred to as a “solid image” including a number of solid image elements such as business graphics for a graph or the like, an image referred to as a “halftone image” such as a natural image including a number of intermediate gradation values and an image referred to as a “light image” which is a relatively bright image including a number of low gradation values.

In order to print such images, a printing operator (hereinafter also referred to simply as an “operator”) manually adjusts each control parameter for the printing machine in response to each image. Thus, printed matter can be created in a proper state.

However, the printing operator in charge of such adjustment of the control parameter responsive to the type of the image must be skilled in the art, in order to make excellent adjustment. Thus, it is not easy to excellently adjust the control parameter in printing.

### SUMMARY OF THE INVENTION

According to a first aspect of the present invention, a print control unit supplying a print control instruction to a printing machine comprises feature acquisition device acquiring a feature of an image to be printed on a printing medium and adjusting device adjusting a vulue of a control parameter related to the printing machine in response to the feature of the image acquired by the feature acquisition device.

According to the first aspect of the present invention the feature of the image is acquired for adjusting the value of the control parameter related to the printing machine in response to the acquired feature of the image, whereby the control parameter for the printing machine can be excellently and readily adjusted.

According to a second aspect of the present invention, the feature acquisition device acquires the feature of the image on the basis of frequency distribution varying with gradation on values related to the image.

According to the second aspect of the present invention, the feature of the image is acquired on the basis of the frequency distribution varying with the gradation values related to the image, whereby the feature of the image can be automatically and readily determined.

According to a third aspect of the present invention, the featured acquisition device acquires the feature of the image as an instruction from an operator.

According to the third aspect of the present invention, the feature of the image is acquired in response to the instruction received from the operator, whereby the intension of the operator can be reflected.

The present invention is also directed to a method of controlling a printing machine and a recording medium recording a program for making a computer function as the aforementioned print control unit.

Accordingly, an object of the present invention is to provide a print control unit capable of excellently and simply adjusting a control parameter for a printing machine in response to the feature of a printed image and a technique related thereto.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically illustrates the system structure of a printing system 1 according to an embodiment of the present invention;

FIG. 2 schematically illustrates the internal structure of a printing machine 30;

FIG. 3 is a conceptual diagram showing the hardware structure of a controller 20;

FIG. 4 is a functional block diagram of the controller 20;

FIG. 5 illustrates an inference operation (control operation) in an inference part 21:

FIG. 6 illustrates fuzzy rules in the inference operation;

FIG. 7 illustrates an exemplary “solid image”;

FIG. 8 illustrates an exemplary “halftone image”;

FIG. 9 illustrates an exemplary “light image”;

FIG. 10 is a flow chart schematically illustrating operations;

FIG. 11 illustrates an image analyzing opinion;

FIG. 12 illustrates an image analyzing operation as to a color plate;

FIG. 13 illustrates an image analyzing opinion as to a total plate;

FIG. 14 illustrates an image analyzing opinion for each control channel,

FIG. 15 illustrates frequency distribution for respective control channels in a single color plate;

FIG. 16 illustrates control of an ink feed rate;

FIG. 17 illustrates control of a water feed rate;

FIG. 18 illustrates control of a printing pressure; and

FIG. 19 is a flow chart showing an operation;

### DESCRIPTION OF THE PROFFERED EMBODIMENTS

<First Embodiment>

<A1. Structure>

<Outline>

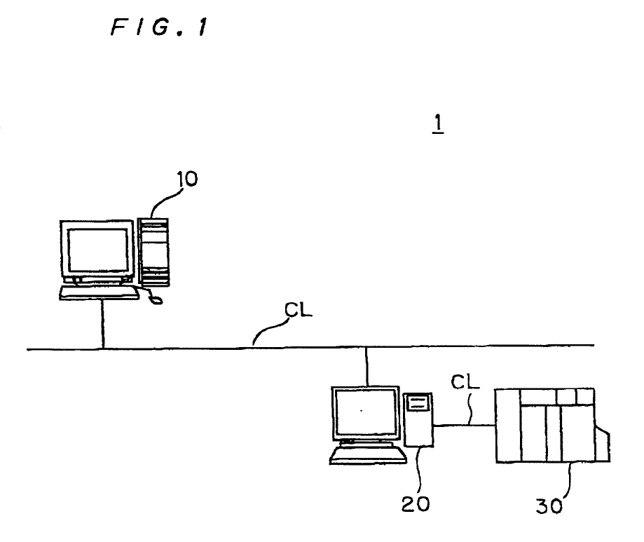

FIG. 1 schematically illustrates the system structure of a printing system 1 according to an embodiment of the present invention.

As shown in FIG. 1, this printing system 1 comprises a printing machine printing output unit) 30 performing printing on the basis of digital data and a print control unit (hereinafter referred to as a “controller”) 20 rasterizing the digital data to be printed and supplying the rasterized digital data to the printing machine 30. The controller 20 and the printing machine 30 are connected with each other through a communication line CL, and capable of transmitting/receiving various types of information to/from each other.

This printing system 1 makes printing output through the printing machine 30 on the basis of a print control instruction received from the controller 20.

A client computer (hereinafter also referred to as a “client”) 10 arranged on a front end is connected to the controller 20 through the communication line CL. This client 10 can serve a role of instructing a job to the controller 20.

<Printing Machine 30>

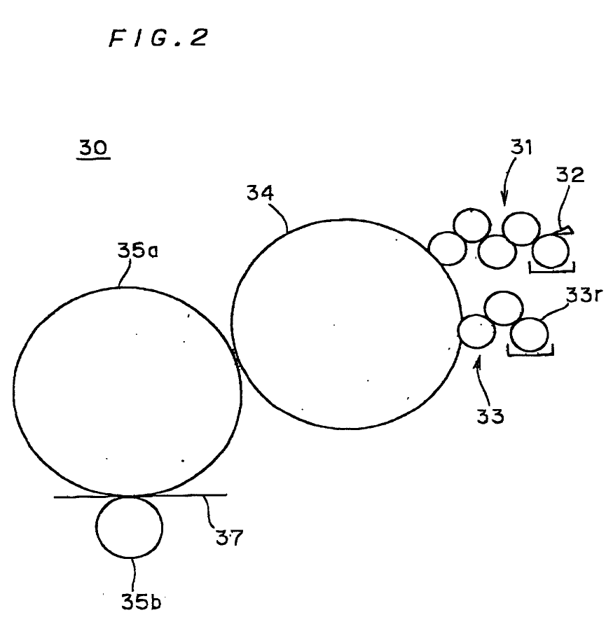

FIG. 2 schematically illustrates the internal structure of the printing machine 30. The printing machine 30, illustrated as an offset printing machine in FIG. 2, may alternatively be formed by another type of printing machine, as a matter of course.

In this printing machine 30, ink and damping water supplied to a plate cylinder 34 are temporarily moved to a blanket cylinder 35a and thereafter transferred to a printing paper 37, as shown in FIG. 2. In this transfer, a pressure (printing pressure) is applied to the printing paper 37 held between the blanket cylinder 35a and an impression cylinder 35b. Thus, an image is formed on the printing paper 37.

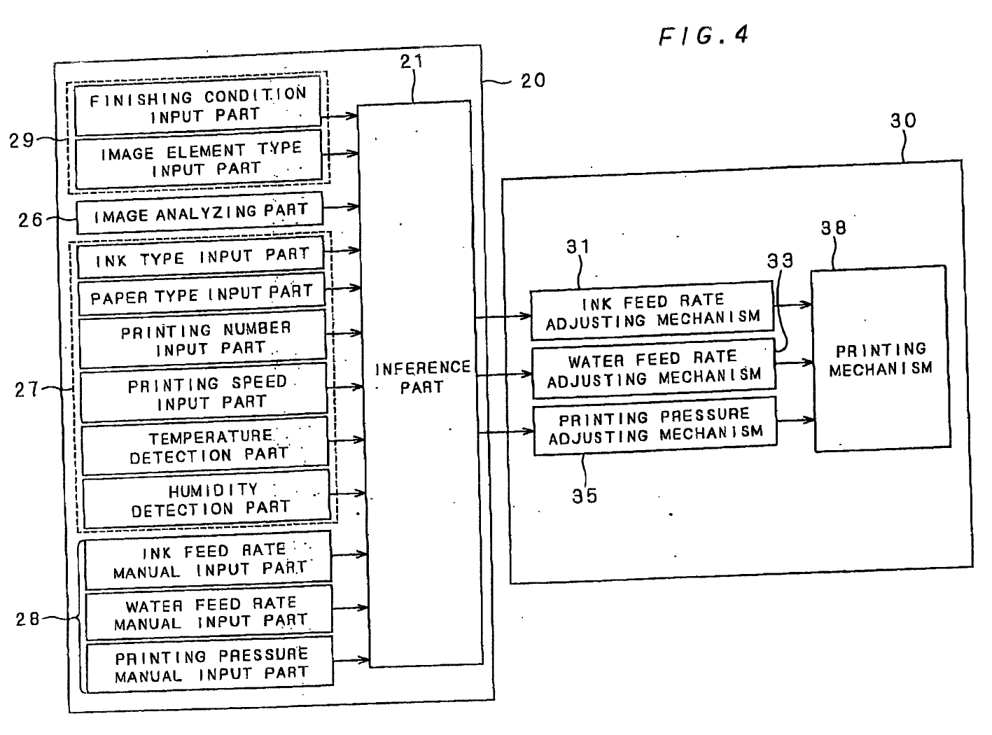

The printing machine 30 further comprises an ink feed rate adjusting mechanism 31, a water feed rate adjusting mechanism 33 and a printing pressure adjusting mechanism 35 (FIG. 4). The ink feed rate adjusting mechanism 31 has an ink key 32, so that the feed rate of the ink for the plate cylinder 34 can be adjusted by changing the degree of opening/closing of the ink key 32. The water feed rate adjusting mechanism 33 can adjust the feed rate of the damping water (hereinafter also referred to simply as a “water feed rate”) by adjusting the rotational frequency of a water raising roller 33r. The printing pressure adjusting mechanism 35 (not shown in FIG. 2) has a mechanism for adjusting the distance between the blanket cylinder 35a and the impression cylinder 35b, for controlling the printing pressure by adjusting the distance between the cylinders 35a and 35b.

As hereinabove described, the ink feed rate adjusting mechanism 31 adjusts the ink feed rate, the water feed rate adjusting mechanism adjusts the water feed rate, and the printing pressure adjusting mechanism 35 adjusts the printing pressure. The ink feed rate, the water feed rate and the printing pressure are controlled on the basis of an instruction from the controller 20.

<Controller 20>

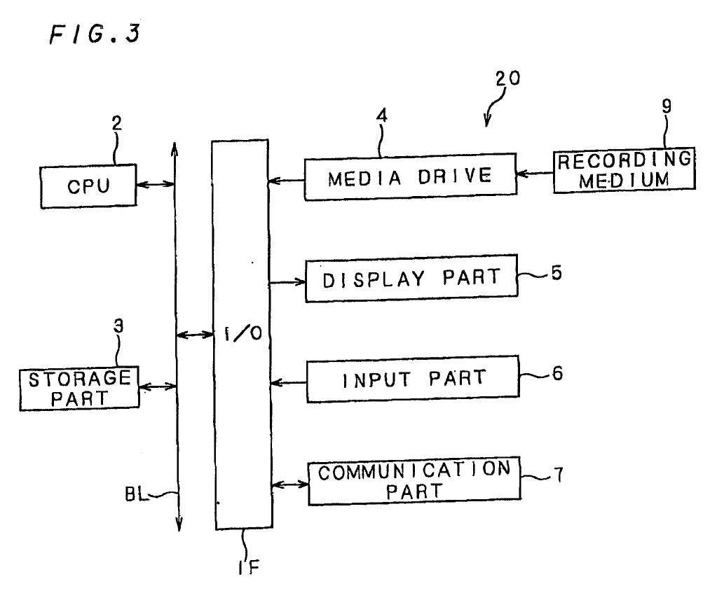

FIG. 3 is a conceptual diagram showing the hardware structure of the controller 20. As shown in FIG. 3, the controller 20 is formed by a computer system (hereinafter also referred to simply as a “computer”) comprising a CPU 2, a storage part 3 including a semiconductor memory and a hard disk etc., a media drive 4 reading information from various types of recording media, a display part 5 including a monitor etc., an input part 6 including a keyboard and a mouse etc. and a communication part 7 communicating with another device. The CPU 2 is connected with the storage part 3, the media drive 4, the display part 5, the input part 6, the communication part 7 etc. through a bus line BL and an input/output interface IF. The media drive 4 reads information recorded in a portable recording medium 9 such as a CD-ROM, a DVD (digital versatile disk) or a flexible disk.

This computer reads a software program (hereinafter also referred to simply as a “program”) recorded in the recording medium 9 and executes this program with the CPU 2 etc., thereby functioning as the controller 20 implementing various operations as described later. The program (more strictly, a “program file” recording program having respective functions) having respective functions is not restrictively supplied (or distributed) through the recording medium 9 but may alternatively be supplied (or distributed) to the computer through a network (communication line) such as LAN or the Internet and the communication part 7.

Thus, the controller 20 is a device constructed in a software manner with the computer.

FIG. 4 is a functional block diagram of the controller 20. The functions of the controller 20 are now described with reference to FIG. 4.

The controller 20 comprises an inference part 21. The inference part 21 decides the values of control parameters for the printing machine 30 by fuzzy inference in response to various types of entries including the feature of an image to be printed on a printing medium and adjusts the values of the control parameters (hereinafter also referred to as “printing parameters”) for the printing machine 30 in response to the results of the inference. It is assumed that the inference part 21 controls the ink feed rate, the water feed rate and the printing pressure as the printing parameters.

The controller 20 further comprises an image analyzing part 26, a printing condition setting part 27, a manual control part 28 and a feature specific part 29.

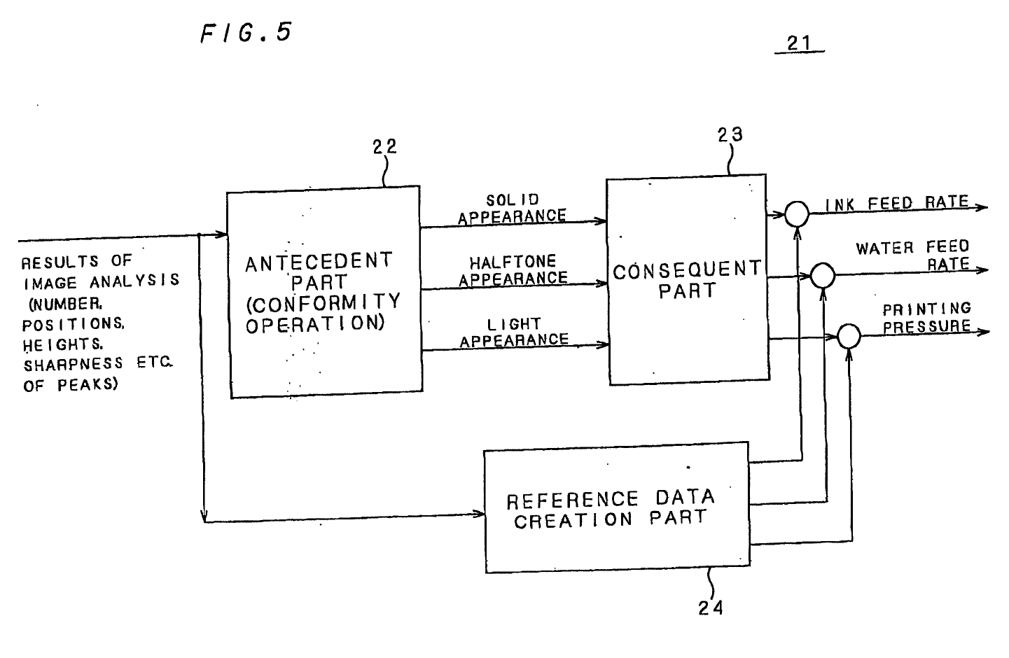

The image analyzing part 26 is a processing part analyzing the image to be printed on the printing medium. More concretely, the image analyzing part 26 obtains frequency distribution varying with gradation values related to the image. An operation part 22 (FIG. 5) of the inference part 21 described later can automatically acquire the feature (“solid”, “halftone” or “light”) of the image with the result of this analysis.

The printing condition setting part 27 is a processing part setting printing conditions such as the paper type, the printing number and the printing speed. These printing conditions, automatically set with reference to information included in document data to be printed on the printing medium, may alternatively be set through a manual entry of an operator. The printing condition setting part 27 also sets environmental conditions such as the temperature and humidity. The environmental conditions are automatically set through results of measurement with a thermometer and a hygrometer.

The manual control part 28 is employed for manually adjusting the printing parameters such as the ink feed rate, the water feed rate and the printing pressure. This manual control part 28 can be employed for further correcting the results of automatic adjustment obtained by the fuzzy inference of the inference part 21 or manually adjusting the printing parameters such as the ink feed rate in place of fuzzy inference.

The feature specifying part 29 accepts the entry made by the operator in relation to the feature (“solid”, “halftone” or “light”) of the image thereby specifying the feature of the image. When the feature of image is manually specified through the feature specifying part 29, the controller 20 can acquire the feature of the image for the printed matter. In other words, the controller 20 can also acquire the feature of the image through an entry made by the operator in place of the results of the automatic analysis by the image analyzing part 26. The feature specifying part 29 can specify the feature of the image by directly inputting the type “solid”, “halftone” or “light”) of the image element or may set a “finishing condition” such as “light” or “dark”.

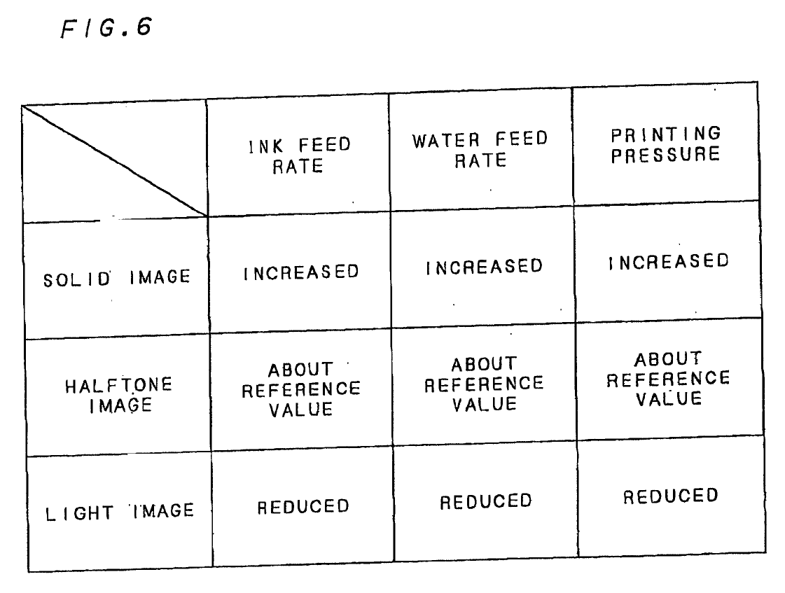

FIG. 5 illustrates an inference operation (control operation) in the inference part 21, and FIG. 6 illustrates fuzzy rules in the inference operation.

As show in FIG. 5 the inference part 21 comprises an operation part (hereinafter also referred to simply as an “antecedent part”) 22 operating a degree of conformity (a fitness value) related to antecedent parts of the fuzzy rules and another operation part (hereinafter also referred to simply as a “consequent part”) 23 carrying out operations related to consequent parts of the fuzzy rules, for deciding the control parameters, i.e., the ink feed rate, the water feed rate and the printing pressure with the fuzzy rules. The inference part 21 also comprises a reference data creation part 24. The inference part 21 corrects reference data (reference values) created by the reference data creation part 24 on the basis of the results of image analysis while reflecting results obtained by fuzzy inference, thereby adjusting the control parameters.

Rules for deciding the control parameters in response to the feature of the image can be employed as the fuzzy rules. More concretely, the ink feed rate can be decided on the basis of rules (1) increasing the ink feed rate beyond the reference value if the image is a “solid image”, (2) setting the ink feed rate to about the reference value if the image is a “halftone image”, and (3) reducing the ink feed rate beyond the reference value if the image is a “light image”, for example, for the ink feed rate, as shown in FIG. 6.

For example, the degree of conformity for the proposition of the antecedent part of the aforementioned rule (1) stating that the image is a “solid image” may be obtained so that the degree for increasing the ink feed rate can be decided in response to the degree of conformity. Also as to the remaining rules (2) and (3), the degree of conformity for the propositions of the antecedent parts thereof may be obtained so that the degree of increasing/reducing the ink feed rate can be decided in response to the degree of conformity. The value of each control parameter can be finally decided by weighting the value obtained on the basis of the three rules (1) to (3).

The degree of conformity for the conditions s of the antecedent parts in these fuzzy rules can be set on the basis of frequency distribution related to gradation values of pixels in the image. More concretely, results of analysis in the image analyzing part 26 described below can be employed.

As described above, the controller 20 has the image analyzing part 26 (FIG. 4) analyzing the image for the printed matter. This image analyzing part 26 analyzes the image for the printed matter with the frequency distribution as to the gradation values of the pixels in the image. More concretely, the image analyzing part 26 acquires the feature of the image in consideration of elements such as the number, positions, heights and sharpness of peaks in the frequency distribution.

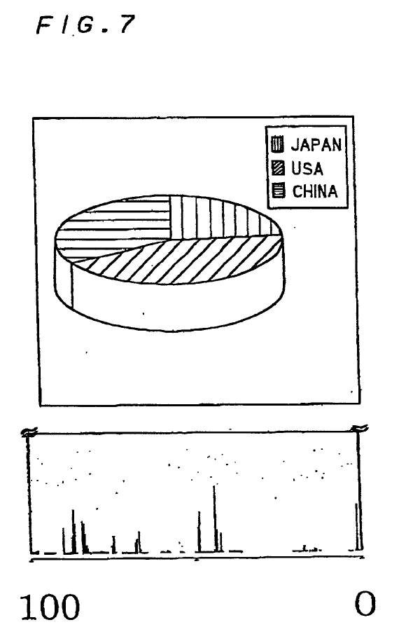

FIGS. 7 to 9 illustrate exemplary “solid”, “halftone” and “light” images respectively along with frequency distribution of gradation values of pixels included in the images. In each of these figures, the horizontal axis of the lower graph shows the gradation values of the pixels, and the vertical axis shows the frequencies of the gradation values. The gradation values are standardized to numerical values from zero to 100, and it is assumed that smaller values indicate brighter (whiter) gradation values.

FIG. 7 shows the “solid image” formed by portions having vertical lines, horizontal lines and slant lines in different colors, more concretely, red, blue and green) in a circular graph on the upper part with a frequency distribution graph of the gradation values on the lower part. As shown in FIG. 7, the “solid image” has some sharp peaks in the frequency distribution, and some of the peaks are distributed around 100%. As described later, an image having sharp peaks is determined as an image having “solid” appearance.

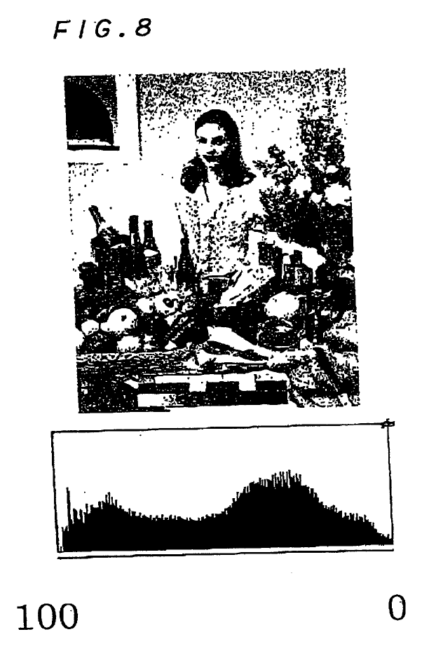

FIG. 8 shows a photographic image including various colors on the upper part with a frequency distribution graph of the gradation values thereof on the lower part. As shown in FIG. 8, the “halftone image” has flat distribution with no steep peaks or distribution with centrally concentrated peaks. As described later, an image having a small number of sharp peaks with flat or centrally concentrated distribution is determined as an image having “halftone” appearance.

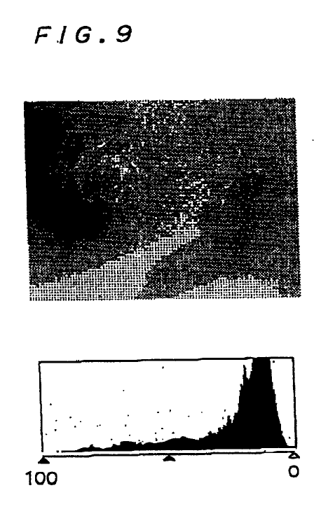

FIG. 9 shows a bright image on the upper part with a frequency distribution graph of the gradation values thereof on the lower part. As described later, an image having distribution relatively concentrated to portions having low gradation values is determined as an image having “light” appearance.

Such “solid” appearance, “halftone” appearance and “light” appearance can be converted to numerical value as the degree of conformity. That is, the degree of conformity for the proposition of the antecede parts can be set. In other words, the antecedent part 22 (FIG. 5) of the inference part 21 can automatically acquire the feature (“solid”, “halftone” or “light”) of the image through the results of analysis by the image analyzing part 26. The values of the control parameters can be decided by applying rules of the consequent parts on the basis of the degree of conformity set in this manner. These operations are described later in detail.

While the above description has been made with respect to the rules for the ink feed rate, similar rules can be employed also as to the water feed rate and the printing pressure. For example, the water feed rate can be decided on the basis of rules (1) increasing the water feed rate beyond the reference value if the image is a “solid image”, (2) setting the water feed rate to about the reference value if the image is a “halftone image” and (3) reducing the water feed rate beyond the reference value if the image is a “light image”, as shown in FIG. 6. Further, the printing pressure can be decided on the basis of rules (1) increasing the printing pressure beyond the reference value if the image is a “solid image”, (2) the printing pressure to about the reference value if the image is a “halftone image” and (3) reducing the printing pressure beyond the reference value if the image is a “light image”.

<A2. Operation>

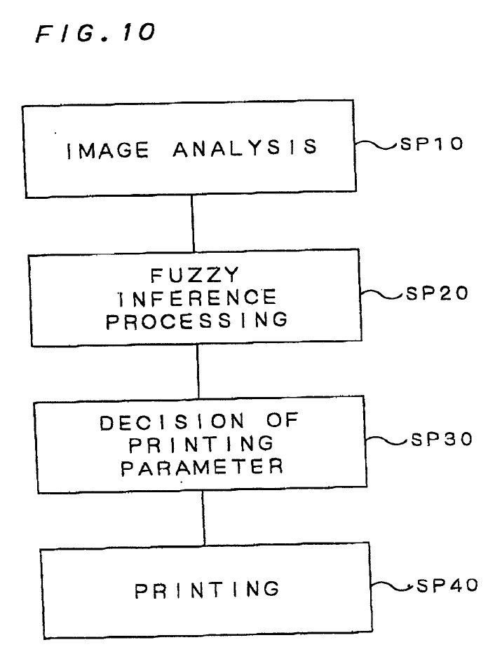

The control operations of the control system 1 are now described. FIG. 10 is a flow chart schematically illustrated the operations.

<Image Analysis>

First, image analysis is performed at a step SP10.

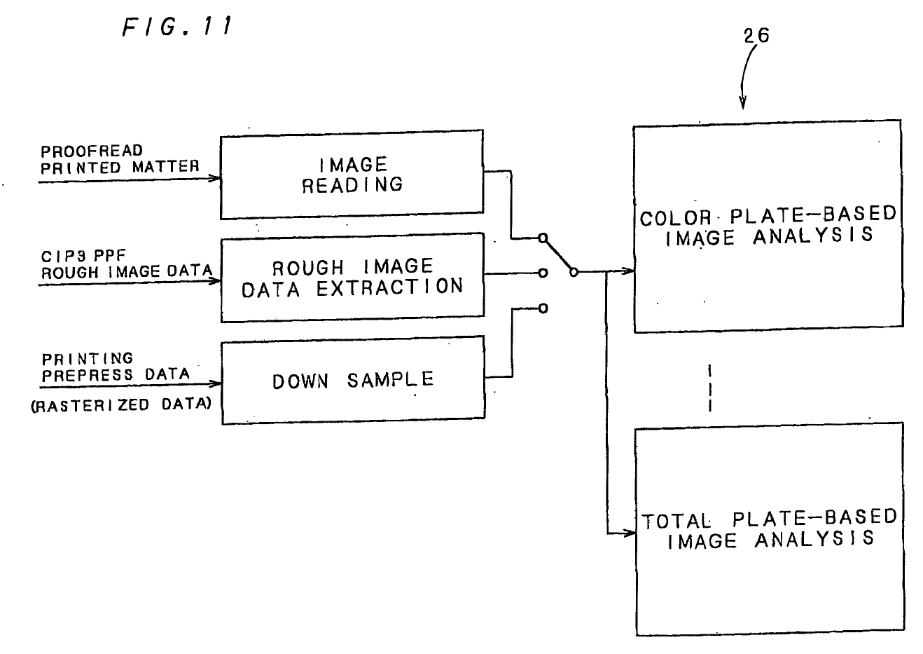

FIG. 11 illustrate the image analysis. In this case, features of images of color plates (for example, a C (cyan) plate, an M (magenta) plate, a Y (yellow) plate and a K (black) plate) forming a completed image are analyzed while the feature of a total plate image which is a gray scale image of the completed image is also analyzed. The whole feature can be precisely grasped and reflected on the printing operation by taking not only the features of the color plate-images but also the feature of the total plate image into consideration

As shown in FIG. 11, image data prepared by reading and inputting an image of proofread printed matter with an image reader such as a scanner can be employed as the object of the image analysis. Alternatively, rasterized data subjected to rasterization may be employed as the object of the image analysis. Further alternatively, rough image data extracted from CIP3 (Trade Mark) (International Cooperation for Integration of Prepress, Press and Postpress)-PPF (Pot Production Format) related to the printed matter may be employed. The CIP3-PPF data includes various conditions and images in steps of prepressing and printing in relation to the printed matter.

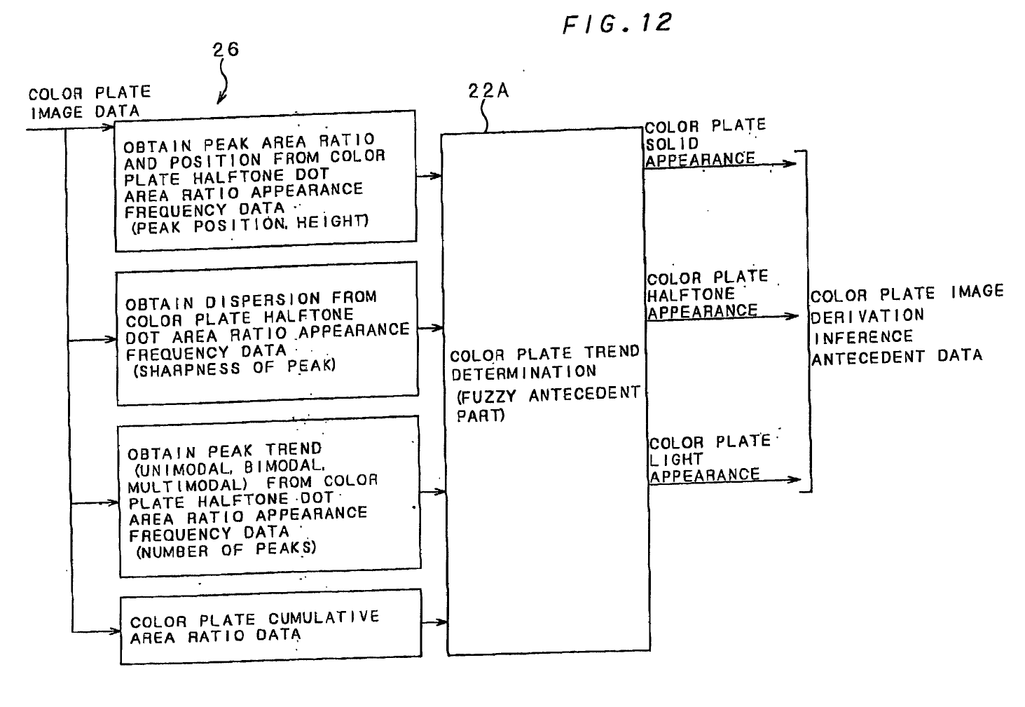

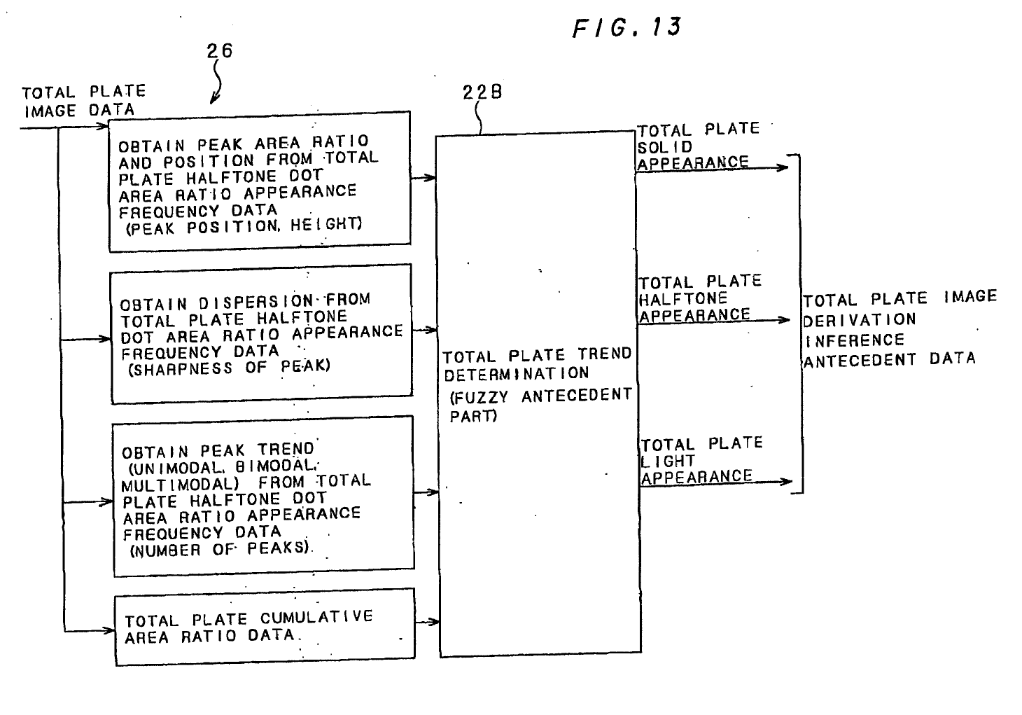

The input image is analyzed every color plate image and also as a total plate image. FIGS. 12 and 13 show image analyzing operations as to each color plate image and as to the total plate image respectively.

As shown in FIGS. 12 and 13, the image analyzing part 26 analyzes the image on the basis of the number, positions, heights and sharpness of the peak in the frequency distribution of the gradation values as to the image. The image analyzing part 26 obtains the number, positions, heights and sharpness of the peaks in the frequency distribution of the gradation values as to both of each color plate image (see FIG. 12) and the total plate image (see FIG. 13).

More concretely, a peak trend as to whether the frequency distribution has one, two or more peaks can be obtained as “the number of peaks”. “The positions of peaks” can be obtained as gradation values where the peaks are present. Further, absolute values of degrees of distribution at the respective peaks, values indicating the degrees of distribution at the respective peaks in ratios to the total number of degrees or the like can be employed as “the heights of peaks”. In addition, numerical values prepared by obtaining dispersion directed to all gradation values or a plurality of pixels having gradation values in the vicinity of the peaks can be employed for “the sharpness of peaks”.

<Fuzzy Inference Antecedent Part>

At a step SP20, the values of the control parameters related to the printing machine 30 are adjusted in response to the feature of the image acquired at the step S10.

First, the antecedent part 22 (FIG. 5 for the fuzzy inference determines the feature of each image.

The feature of the image is acquired on the basis of the result of the image analysis by the image analyzing part 26 (FIG. 4). In this case, “solid” appearance, “halftone” appearance or “light” appearance is acquired as the feature of the image. The “gradation value” can also be expressed as the “halftone area ratio” of a halftone-dot image.

As hereinabove described, the feature of the image is set on the basis of the number, positions, heights sharpness of the peak in the frequency distribution of the gradation values of each image.

For example, the image having sharp peaks as shown in FIG. 7 is determined as an image appearing “solid”. The degree of conformity for the proposition of the antecedent part stating that the image is a solid image can be set as a relatively high value (for example, 0.9). Also as to the “halftone” appearance and the “light” appearance, the degree of conformity for each proposition is similarly obtained. In this case, it comes to that relatively low degree of conformity is supplied to the “halftone” appearance. As to the “light” appearance, the degree of conformity responsive to the peak positions is supplied such that relatively low degree of conformity is supplied when the peak positions are present on a higher gradation side while relatively high degree of conformity is supplied when the same are present on a lower gradation side.

When peaks in the frequency distribution are not sharp and the frequency distribution is wide over the center or all gradation, values as shown in FIG. 8, the degree of conformity for the proposition stating a “halftone” image is determined to have a relatively high value, and it follows that relatively low degree of conformity is supplied to each of the “solid” appearance and the “light” appearance.

When the peak positions in the frequency distribution are present on a light gradation side a shown in FIG. 9, the degree of conformity for the proposition stating a “light ” is determined to have a relatively high value while it follows that relatively low degree of conformity is supplied to each of the “solid” appearance and the “halftone” appearance.

After the result of analysis related to the frequency distribution of each color plate image is input in a color plate trend determination part 22A, the aforementioned degree of conformity for each proposition of the antecedent part is obtained, as shown in FIG. 12. The degree of conformity obtained in the color plate trend determination part 22A serving as the antecedent part is transferred to the consequent part 23. As the result of the analysis related to the frequency distribution of each color plate image, other elements such as cumulative area ratio data can also be properly employed in addition to the aforementioned number, positions, heights and sharpness of the peaks.

After the result of analysis related the frequency distribution of the total plate image is input in a total plate red determination part 22B, the aforementioned degree of conformity for each proposition of the antecedent part is obtained, as shown in FIG. 13. The degree of conformity obtained in the antecedent part is transferred to the consequent part 23. As the result of the analysis related to the frequency distribution of the total plate image, other elements such as cumulative area ratio data can also be properly employed in addition to the aforementioned number, positions, heights and sharpness of the peaks.

While the feature of the overall images grasped as to each color plate data or the total plate data in the above description, the present invention is not restricted to this but the feature of an image in each sectional are a of a plate image may alternatively be grasped. For example, an area obtained by separating an image in response to the width of each ink key can be assumed as the sectional area of the plate image.

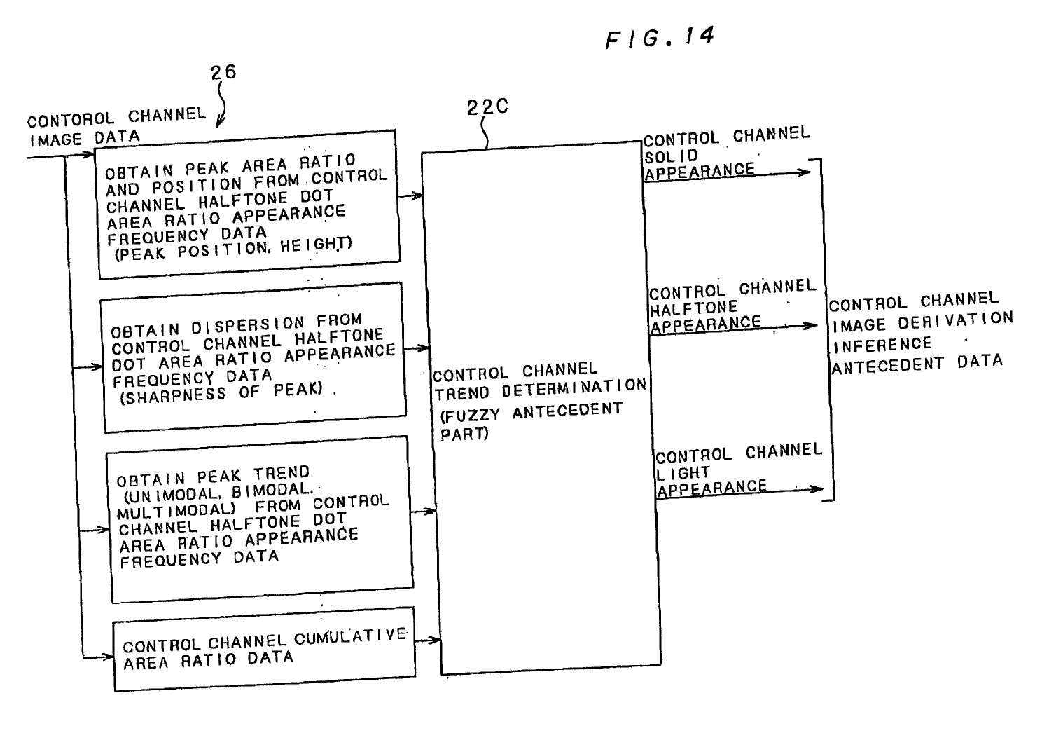

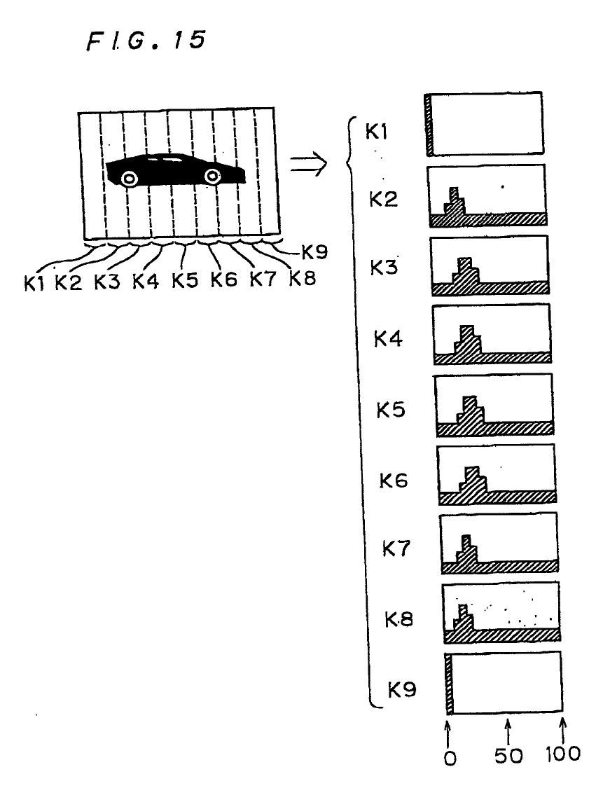

FIG. 14 illustrates an operation of acquiring the feature of an image for each control channel similarly to the above. The term “control channel” stands for each of areas obtained by separating each color plate images in units of widths of ink keys, i.e., a unit of ink feed rate control employing ink keys. FIG. 15 illustrates frequency distribution of each control channel in a single color plate (K plate) for an image shown on the left side. FIG. 15 illustrates gradation distribution of it areas K1 to K9 forming the control channels as to the K plate.

It is assumed that the feature of the image every control channel is also taken into consideration. Therefore, the degree of conformity for each proposition of the aforementioned antecedent part can be obtained after inputting the result of analysis related to the frequency distribution of each control channel for each color plate in a control channel trend determination part 22C, as shown in FIG. 14. The degree of conformity obtained in the antecedent part is the transferred to the consequent part 23. Thus, the feature of the image can be reflected every control channel.

Fuzzy Inference Consequent Part and Decision of Printing Parameter>

Then, the consequent part 23 (FIG. 5) for the fuzzy inference decides the control parameters reflecting the feature of each image on the basis of the fuzzy rules. More concretely, the consequent part 23 overlaps results obtained from the respective rules and adjusts the respective control parameters in consideration of the degree of conformity in the antecedent part.

The following description is made with reference to a case of setting the control parameters by increasing/decreasing the same with respect to the “reference values”, i.e., deciding the degrees of adjustment of the control parameters with respect to the reference values by fuzzy inference.

The reference values for the control parameters are decided on the basis of the parameters such as the ink types, the paper types, the temperature, the humidity, the printing speed and the printing number. Standard reference values can be properly, decided on the basis of these parameters. As to the printing number, for example, a reference value reflecting flattening (abrasive deterioration) of the plates or the like can be set by taking the number of prints into consideration. It is also possible to set a reference value reflecting influence exerted by the environment for the printing machine 30 by considering the temperature. Theses parameters are input in the printing condition setting part 27 shown in FIG. 4.

Thereafter the control parameters (printing parameters) for the printing machine 30 are finally decided at a step SP30 on the basis of the results of the inference in the step SP20.

Therefore, the control parameters set to the reference values are corrected with the results obtained by the fuzzy inference reflecting the feature of the image. More concretely, final control parameters can be decided by multiplying the control parameters by ratios of correction to the aforementioned reference values or adding correction values to the reference values.

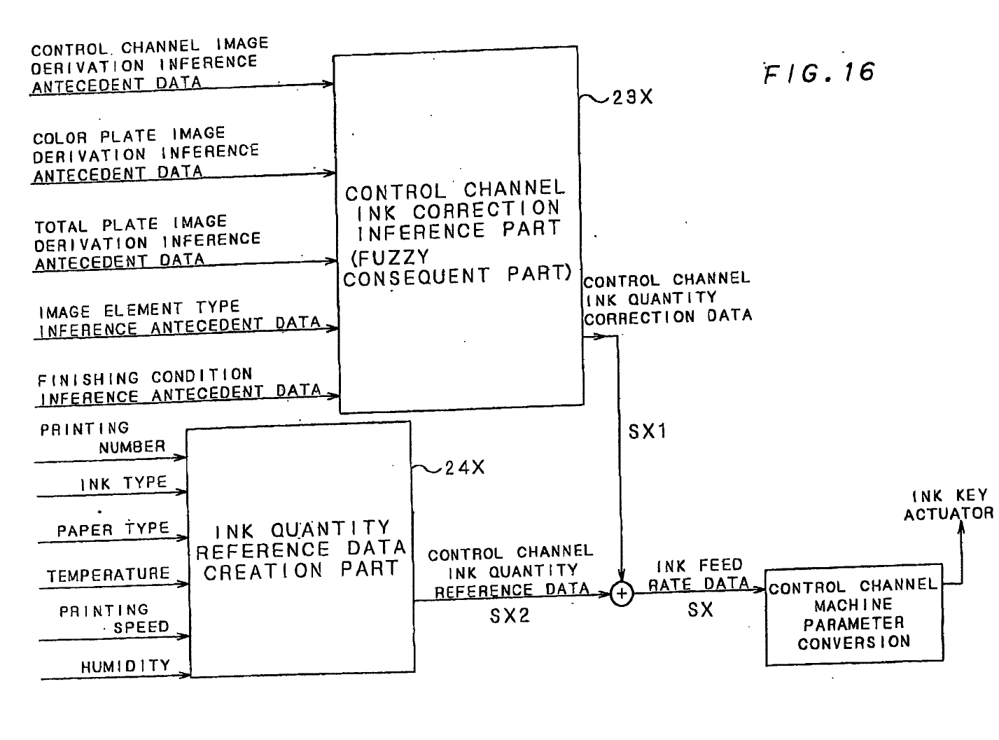

Ink quantity control is first described with reference to FIG. 16. The ink feed rate is controlled every control channel (ink key) provided for each color plate.

As shown in FIG. 16, ink quantity correction data SX1 calculated by a fuzzy consequent part 23X is added to ink quantity reference data SX2 created by an ink quantity reference data creation part 24X, Hereby deciding ink feed rate data SX.

More concretely, the features of each color plate image, the total plate image and the control channel image obtained in the antecedent part 22 are input in the ink correction inference part 23X for each control channel. In response thereto, the ink correction inference part 23X forming the consequent peat for the fuzzy inference decides the ink quantity correction data SX1 for each control channel. The ink feed rate data SX can be firmly obtained by adding the ink quantity correction data SX1 calculated by the ink correction inference part 23X to the ink quantity reference data SX2 created by the ink quantity reference data creation part 24X. Thus, the respective ones of the features of the image acquired in units of the color plates, the total plate and the respective control channels in the color plates can be reflected on the control parameter for the ink feed rate.

The controller 20 transmits the ink feed rate data SX to the printing machine 30, which turn converts the received ink feed rate data SX to a mechanical parameter and controls an ink key actuator. Thus, the aperture of the ink key for each control channel is adjusted to a proper value.

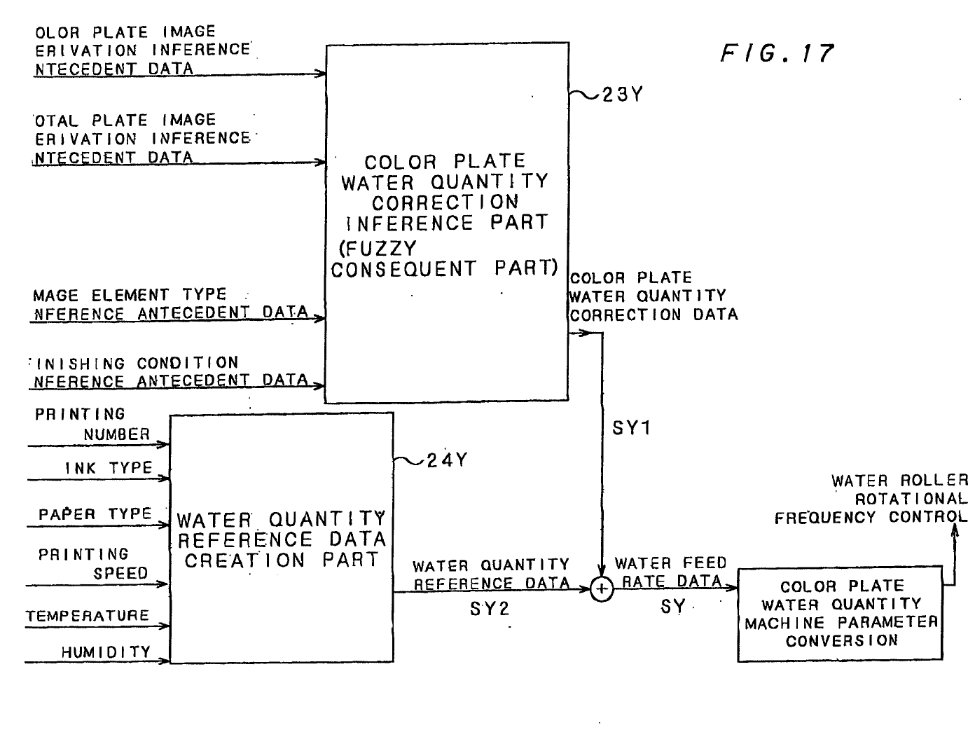

Similarly, water feed rate data SY can be obtained by adding water quantity correction data SY1 calculated by a fuzzy consequence past to water quantity reference data SY2, as showing in FIG. 17.

More concretely, the features of each color plate image and the total plate image obtained in the antecedent part 22 am input in a color plate water quantity correction inference part 23Y forming the consequent part for the fuzzy inference, which in turn decides the water quantity correction data SY1 for each color plate. The water feed rate data SY can be finally obtained by adding the water quantity correction data SY1 calculated by the color plate water quantity correction inference part 23Y to the water quantity reference data SY2 created by a water quantity reference data creation part 24Y.

The controller 20 transmits the water feed rate data SY to the printing machine 30, which in turn converts the received water feed rate data SY to a mechanical parameter (more concretely, the rotational frequency of a water roller) for controlling the water roller. Thus, the water feed rate for each color plate is adjusted to a proper value. The water feed rate is decided every color plate.

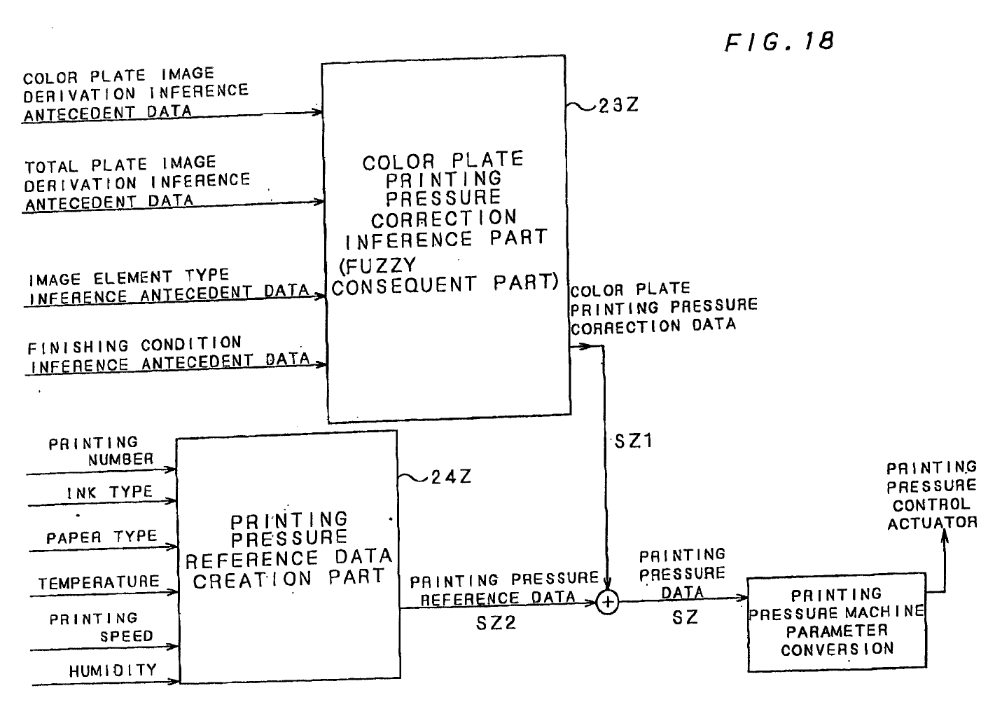

As to the printing pressure, printing pressure data SZ can be obtained by adding priding pressure correction data SZ1 calculated by a fuzzy consequent part to printing pressure reference data SZ2, as shown in FIG. 18.

More concretely, the features of each color plate image and the total plate image obtained in the antecedent part 22 are input in a color plate printing pressure correction inference part 23Z forming the consequent part for the for the fuzzy inference, which in turn decides the printing pressure correction data SZ1 for each color plate. The printing pressure data SZ can be finally obtained by adding the printing pressure correction data SZ1 calculated by the color plate printing pressure, correction inference part 23Z to the printing pressure reference data SZ2 calculated by a printing pressure reference data creation part 24Z.

The controller 20 transmits the printing pressure data SZ to the printing machine 30, which in turn converts the received printing pressure data SZ to a mechanical parameter (more concretely, the distance between the blanket cylinder 35a and the impression cylinder 35b) and controls the printing pressure. Thus, the printing pressure for each color plate is adjusted to a proper value. The printing pressure is controlled every color plate when a single color is assigned to a single plate cylinder (single colors are assigned to a plurality of plate cylinders respectively), while the printing pressure is controlled with a value obtained by combining a plurality of printing pressure set values as to assigned color plates when at least two colors are assigned to a single plate cylinder (at least two colors are assigned to any of a plurality of plate cylinders).

<Print Processing>

At a step SP40, printing is performed on the basis of the printing parameters decided at the step SP30. More concretely, the controller 20 supplies a control instruction including a set instruction (or a change instruction) for the printing parameters to the printing machine 30. The printing machine 30 receiving the control instruction transmitted from the controller 20 performs printing output processing with the adjusted printing parameters responsive to the control instruction.

Thus, proper printing responsive to the feature of the image for the printed matter is implemented.

As to the printing parameters, proper feedback control or the like may also be employed, in order to control the respective control quantities (the ink feed rate etc.) to follow theoretical values obtained by the aforementioned fuzzy inference.

<B. Others>

While the results of the analysis by the image analyzing part 26 are input in the inference part 21 in the aforementioned embodiment, the present invention is not restricted to this but the feature of the image for the printed matter may alternatively be acquired as an instruction from the operator.

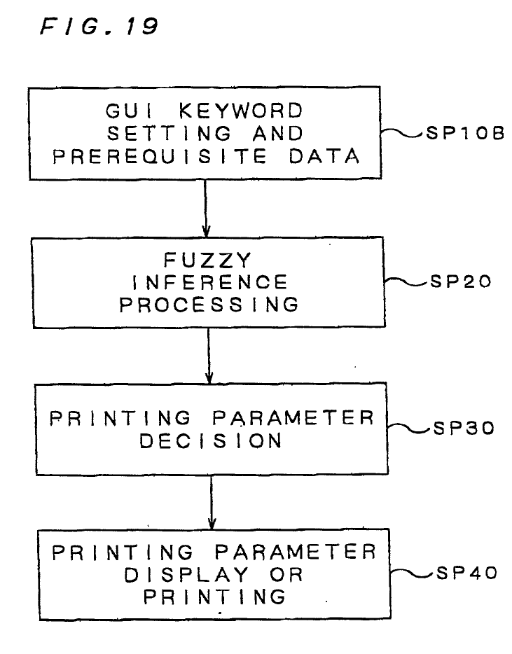

FIG. 19 is a flow chart showing such an operation. Referring to FIG. 19, the operator specifies the aforementioned feature of the image, i.e., “solid”, “halftone” or “light” as a keyword at a step SP10B. More concretely, the operator specifies the degree of the “solid image” with a numerical value, for example. Due to such assistance of the operator, the controller 20 can acquire the feature of the image for the printed matter without requiring feature extraction by the image analyzing put 26. In particular, the intention of the operator can be reflected by employing a simple keyword, thereby simplifying the operation.

While processing following the step SP20 is similar to that of the aforementioned embodiment, the degree of conformity supplied by the aforementioned instruction by the operator can be employed as such in place of operating degree of conformity in the antecedent part on the basis of the results of the analysis in the image analyzing part 26 at the step SP20. At the step SP40, the printing parameters may be displayed in advance of the print processing.

While the printing parameters are set by correcting the same with respect to the reference values responsive to various types of printing conditions in the aforementioned embodiment, the present invention is not restricted to this but the control parameters may alternatively be directly set by assembling various types of printing conditions (the ink type, the paper type, the printing speed etc.) into the fuzzy inference without providing the reference values.

While the printing speed is supplied as a specified value of a constant speed in the aforementioned embodiment, it is also possible to adjust the printing speed in response to the feature of each image or the like. In this case, the “printing speed” may also be decided through fuzzy inference or the like, similarly to the remaining printing parameters such as the ink feed rate.

While the printing parameters are decided with the fuzzy inference in the aforementioned embodiment, the present invention is not restricted to this but the printing parameters may alternatively be decided through a neural network or the like.

The present invention may be embodied by either a computer system controlled in accordance with software programs or a hardware system having individual hardware elements for conducting the respective steps as described in the preferred embodiments. Both of the software elements and the hardware elements arc included in the terminology of “devices” which are elements of the system according to the present invention.

While the invention has been shown and described in detail, the foregoing description is in all aspects illustrative and not restrictive. It is therefore understood that numerous modifications and variations can be devised without departing from the scope of the invention.

What is claimed is:

1. A print control unit supplying a print control instruction to a printing machine, comprising:
feature acquisition device acquiring a feature of an image to be printed on a printing medium; and
adjusting device adjusting a value of a control parameter related to said printing machine in response to the feature of said image acquired by said feature acquisition device.

2. The print control unit according to clam 1, wherein
said feature acquisition device acquires at least any of solid appearance, halftone appearance and light appearance as the feature of said image.

3. The print control unit according to claim 2, wherein
said feature acquisition device acquires the feature of said image on the basis of frequency distribution varying with gradation values relate to said image.

4. The print control unit according to claim 3, wherein
said feature acquisition device acquires the feature of said image on the basis of at least any of the number, positions, heights and sharpness of peaks in said frequency distribution.

5. The print control unit according to claim 4, wherein
said feature acquisition device acquires the feature of said image on the basis of least any of input image data as to proofread printed matter, image data included in document data and rasterized data subjected to rasterization.

6. The print control unit according to claim 5, wherein
said control parameter includes a parameter related to at least any of an ink feed rate, a water feed rate and a printing pressure in said printing machine.

7. The print control unit according to claim 2, further comprising reference value set device setting a reference value for said control parameter, wherein
said adjusting device corrects said reference value in response to the feature of said image thereby adjusting said control parameter.

8. The print control unit according to claim 7, wherein
said reference value is decided on the basis of at least one parameter among a temperature, humidity, a printing speed and a printing number.

9. The print control unit according to claim 2, wherein
said feature acquisition on device acquires the feature of said image as an instruction from an operator.

10. A computer software product including a computer-readable recording medium in which software programs are recorded, wherein said software programs control a computer to operate as a print control said control unit comprising:
feature acquisition device acquiring the feature of an image to be printed on a printing medium; and
adjusting device adjusting the value of a control parameter related to a printing machine in response to the feature of said image acquired by said feature acquisition device.

11. A print control method for a printing machine, comprising steps of:
a) acquiring a feature of an image to be printed on a printing medium; and
b) adjusting a value of a control parameter related to said printing machine in response to the feature of said image acquired in said step a).

12. The print control method according to claim 11, wherein
at least any of solid appearance, halftone appearance and light appearance is acquired as the feature of said image.

13. The print control method according to claim 12, wherein
the feature of said image is acquired on the basis of frequency distribution varying with gradation values related to said image.

14. The print control method according to claim 13, wherein
the feature of said image is acquired on the basis of at least any of the number, positions, heights and sharpness of peaks in said frequency distribution.

15. The print control method according to claim 14, wherein
the feature of said image is acquired on the basis of at least any of input image data as to proofread printed matter, image data included in document data and rasterized data subjected to rasterization.

16. The print control method according to claim 15, wherein
said control parameter includes a parameter related to at least any of an ink feed rate, a water feed rate and a printing pressure in said printing machine.

17. The printing control method according to claim 12, wherein
said step b) includes steps of:
b-1) setting a reference value for said control parameter, and
b-2) correcting said reference value in response to the character of said image thereby adjusting said control parameter.

18. The print control method according to claim 17, wherein
said reference value is decided on the basis of at least one parameter among a temperature, humidity, a printing speed and a printing number.

19. The print control method according to claim 12, wherein
the feature of said image is acquired as an in action from an operator.
